(19) United States
(12) Patent Application Publication
(10) Pub. No.: US 2022/0143538 A1
(43) Pub. Date: May 12, 2022

(54) FILTRATION SYSTEM AND METHOD OF USE THEREOF

(71) Applicant: ENGINEERED MATERIALS, INC., Buffalo Grove, IL (US)

(72) Inventors: Keith W. Donaldson, Buffalo Grove, IL (US); Frank P. Kroekel, Bad Hersfeld (DE)

(21) Appl. No.: 17/503,146

(22) Filed: Oct. 15, 2021

Related U.S. Application Data
(60) Provisional application No. 63/092,500, filed on Oct. 15, 2020.

(51) Int. Cl. B01D 39/16; A62B 23/00; B01D 46/10; A01N 59/20

(52) U.S. Cl. CPC B01D 39/1607; A62B 23/00; B01D 46/10; B01D 2239/0478; B01D 2239/065; B01D 2257/91; B01D 2275/10; A01N 59/20

(57) ABSTRACT

Method and systems for filtration of harmful particles are disclosed herein. In one embodiment, a method for making a filtration system for use with a facial covering includes producing a liquid polymerized copper substate, creating a barrier layer by coating a filter media with the liquid copper substrate to coat the filter media with polymerized copper, and binding the barrier layer between two textile layers, wherein each of the two textile layers provides a tortuous path for particles to pass. A filtration system includes a barrier layer including a filter media coated with particulate copper and a polymer.

### CROSS-REFERENCE TO RELATED APPLICATION

This application claims the benefit of U.S. Provisional Application No. 63/092,500, filed Oct. 15, 2020, the disclosure of which is hereby expressly incorporated by reference herein.

### BACKGROUND

In light of the recent COVID-19 pandemic, protective facial coverings have become increasingly popular throughout the world. Most protective facial coverings are designed to cover the nose and mouth of an infected wearer and prevent harmful substances, such as viruses or bacteria, from being released onto others. Many facial coverings which have become popular include one or more layers of fabric and can include a pocket that is sized to fit a filtration device therein.

Such facial coverings are typically designed such that the air taken in and exhaled by a wearer must pass through the filtration device. Various types of filters are available including, but not limited to paper products (such as coffee filters, paper towels, toilet paper, and the like), high efficiency particulate air (HEPA) filters (such as those found in N95 respirators), mesh fabrics (including, but not limited to, polypropylene materials), activated carbon filters, metallic filters, and the like.

Many of the filtration devices presently on the market are not medical grade and thus do not prevent harmful substances such as microorganisms from passing therethrough. Additionally, most filters that are presently on the market are designed to protect others from an infected wearer who may exhale the harmful substances. As such, there is a need in the field for a filtration device designed to protect both the wearer and those around them from the distribution of harmful microorganisms that can spread disease.

### SUMMARY

In accordance with one embodiment of the present disclosure, an active barrier layer for use in a filtration system is provide. The barrier layer includes: a breathable filter media; and a coating on the filter media wherein the coating includes particulate copper and a polymer, wherein the particulate copper is present in an amount of from about 5 to about 38 percent by weight based on the total weight of the coating, wherein the particulate copper is bound to the polymer to form a polymerized copper substrate.

In another embodiment of the present disclosure, a filtration system for facial coverings is provided. The filtration system includes: a barrier layer having a coating on the filter media, wherein the coating includes particulate copper and a polymer, wherein the particulate copper is present in an amount of from about 5 to about 38 percent by weight based on the total weight of the coating, wherein the particulate copper is bound to the polymer to form a polymerized copper substrate; and at least two textile layers disposed on either side of the barrier layer, wherein the at least two textile layers have filtering properties.

In another embodiment of the present disclosure, a method for making an active barrier layer is provided. The method includes: producing a liquid polymerized copper substate having particulate copper present in an amount of from about 5 to about 38 percent by weight based on the total weight of the coating; creating a barrier layer by coating a breathable filter media with the liquid copper substrate to coat the filter media with polymerized copper.

In another embodiment of the present disclosure, a method for making a filtration system for use with a facial covering is provided. The method includes: producing a liquid polymerized copper substate; creating a barrier layer by coating a filter media with the liquid copper substrate to coat the filter media with polymerized copper; and binding the barrier layer between two textile layers, wherein each of the two textile layers provides a tortuous path for particles to pass therethrough.

In any of the embodiments described herein, the copper particles may be dispersed in a non-contiguous distribution throughout the filter media.

In any of the embodiments described herein, the filter media may be an open cell foam.

In any of the embodiments described herein, the particulate copper may be at least 99% pure copper (Cu+2).

In any of the embodiments described herein, the particulate copper may be present in an amount of from about 12 to about 25 percent by weight based on the total weight of the liquid copper substrate

In any of the embodiments described herein, the particulate copper may be present in an amount of from about 18 to about 25 percent by weight based on the total weight of the liquid copper substrate.

In any of the embodiments described herein, the particulate copper may be present in an amount of from about 18 to about 25 percent by weight based on the total weight of the liquid copper substrate.

In any of the embodiments described herein, the particulate copper may have an increased surface area created by scratching and/or etching.

In any of the embodiments described herein, the particulate copper may be included in an amount effective in killing viruses and bacteria.

In any of the embodiments described herein, the particulate copper may be included in an amount effective in killing coronavirus strains.

In any of the embodiments described herein, the particulate copper may be included in an amount effective in killing bacteria including Staphylococcus aureus and Escherichia coli (E. coli).

In any of the embodiments described herein, the at least two textile layers may have a mesh size sufficient to prevent 99% of all droplets and particles from passing therethrough.

In any of the embodiments described herein, the at least two textile layers may have a mesh size sufficient to prevent particulate copper from passing therethrough.

### BRIEF DESCRIPTION OF THE DRAWINGS

The Detailed Description is set forth with reference to the accompanying figures. The use of the same reference numbers in different figures indicates similar or identical items. Furthermore, the drawings may be considered as providing an approximate depiction of the relative sizes of the individual components within individual figures. However, the drawings are not to scale, and the relative sizes of the individual components, both within individual figures and between the different figures, may vary from what is depicted. In particular, some of the figures may depict components as a certain size or shape, while other figures may depict the same components on a larger scale or differently shaped for the sake of clarity.

FIG. 1A illustrates an illustrative view of various layers of a filtration system according to an embodiment of this application.

FIG. 1B illustrates an enlarged illustrative view of the barrier and textile layers of the filtration system of FIG. 1A, according to an embodiment of this application.

FIGS. 2A and 2B are microscopic views of the filtration system at 10× and 20× respective magnifications with the barrier layer visible through a first textile layer of a filtration system designed according to FIG. 1A.

FIGS. 2C-2E are microscopic views of the filtration system at 100× magnification with the barrier layer visible through a first textile layer of a filtration system designed according to FIG. 1A.

FIG. 2F is a cross-sectional microscopic view of the filtration system at 100× magnification showing the barrier and textile layers of a filtration system designed according to FIG. 1A.

FIGS. 3A-3D are graphs illustrating the effectiveness of the filtration system against various strains of bacteria according to an embodiment of this application.

FIG. 4 is a graph illustrating the effectiveness of the filtration system over a two-hour time periods according to an embodiment of this application.

FIG. 5 is a graph illustrating the inactivation of the Bovine Coronavirus by an exemplary filtering system according to an embodiment of this application.

FIG. 6 is a graph illustrating the inactivation of the Bovine Coronavirus by a second exemplary filtering system according to an embodiment of this application.

### DETAILED DESCRIPTION

This disclosure is directed to a filtration system capable of killing harmful microorganisms, such as bacteria and viruses that can spread disease, for use in reusable facial coverings. In particular, this disclosure describes a three-layer filtration system including an active barrier layer that neutralizes harmful substances and two textile layers that slow or prevent the progress of harmful substances therethrough. More specifically, the active barrier of the filtration system can include a sufficient amount of particulate copper to neutralize the harmful substances that pass through the textile layers.

Copper is scientifically known to interrupt the biological function of various organisms. For example, copper can be used to kill both viruses and bacteria. On the contrary, other materials, such as silver, carbon, and zinc, are known only to be effective against bacteria. The recent COVID-19 outbreak has created a need for facial coverings that are capable of protecting a wearer from viral transmission. While there are some copper filters presently on the market, such copper filters include copper threads or strands which can be woven into a textile material to react with harmful substances as they penetrate the textile. However, due to the distribution of the copper strands throughout the textile material, some harmful particles are able to pass through the filter without coming into contact with the copper. Such copper filters leave a user open to potential exposure to harmful microorganisms that pass through the filter without contacting the copper threads. Additionally, the copper strands typically have very a small surface area capable of interacting with harmful particles, reducing the antimicrobial efficiency of the filter. Alternative copper filters can use copper oxide or copper ions; however such materials can accidentally release copper ions from the filter which can be inhaled by the wearer causing a myriad of other potential health issues.

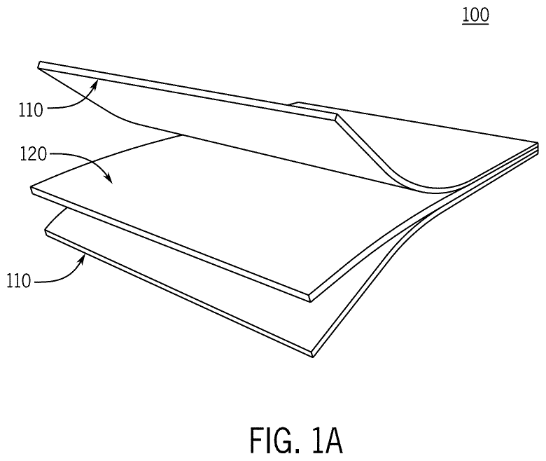

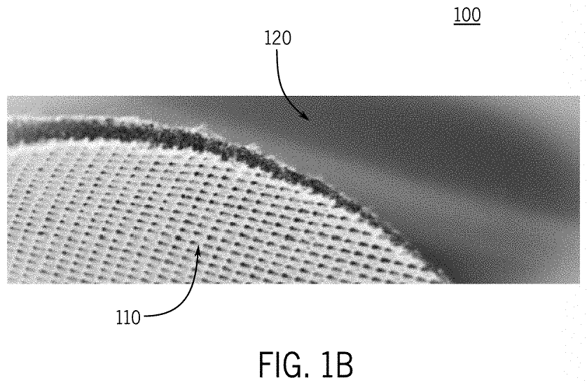

FIG. 1A illustrates an exemplary filtration system 100 that can include multiple layers. In at least one instance, the filtration system 100 can include be a tri-layer system as illustrated in FIG. 1A. However, it should be generally understood that the filtration system 100 can be created using additional or fewer layers. In at least one instance, an active barrier layer 120 can be surrounded on either side by a textile layer 110.

The active barrier layer 120 can include a filter media coated with a copper substrate. Specifically, the filter media can be any open cell and breathable material, which is suitable to be used as a facial covering. In at least one instance, the filter material can be a fabric textile. In the alternative, the filter media can be a breathable, flexible foam including, but not limited to, a polyurethane open cell foam. In yet another alternative, the filter media can be a polyethylene material. Breathable means that the filter media includes holes and passageways suitable sized for human breathability through the filter media.

In one embodiment, the filter media is an open cell foam having a tortuous path therethrough that allows for a suitable resonance time for any air that passes through the active barrier layer 120. The foam layer has a thickness and an open cell sizing that—when coated—allows for a suitable air flow rate for breathability. The materials used in the manufacture of the filtration system described herein include a filter size that allows for the greatest protection, while reducing the dangerous build-up of carbon dioxide (CO₂) on the inside of the facial covering. Many filtration systems which are presently in existence reduce the filter size to obtain better protection, which can result in low blood oxygen levels due to CO₂ build-up. The present filtration system is designed to allow a wearer to use the mask for extended durations with less CO₂ buildup.

To coat the open cell foam with the copper substrate, the open cell foam can be placed into a bath of copper substrate liquid solution allowing the solution to cover both sides of the filter media. The open cell foam is then squeezed through pinch rollers for uniform dispersion in the open cell structure. The saturated foam is then set to dry.

The liquid copper substrate used to saturate the filter media of the barrier layer 120 can include particulate copper suspended within a liquid polymer substrate. The polymer substrate can include solids, such as plastic, to which the copper can bind. Once bound, the liquid copper substrate can then be used to saturate the filter media. In at least one instance, the polymer substrate can be an ink or other polymer material including, but not limited to, an acrylic polymer, a polyurethane, a polyester, or a nylon.

In one embodiment, the copper particles can be present in an amount of from about 5 to about 38 percent by weight of the coating, or any subrange therein. In at least one instance, the copper particles can be present in an amount of from about 12 to about 25 percent by weight of the coating. In another embodiment, the copper particles can be present in an amount of from about 18 to about 25 percent by weight of the coating. The remaining coating solids are polymer solids. In liquid form, the copper particles and polymer solids may be dispersed in water.

As a non-limiting example, an ink solution is formed from one gallon of ink (7.5 #per gallon), 34% solids in the ink (2.55 #solids), and 20% final weight copper (0.638 #copper). This formula yields a copper dry weight of about 21%.

The copper particles can be bound to the polymer chain through high shear mixing of the liquid formula. High shear mixing also mitigates any agglomeration of the copper particles in the liquid.

After coating the filter media with the liquid copper substrate and allowing for drying, a barrier layer 120 having a polymerized copper substrate coating is formed. The coating includes non-contiguous copper particles. The polymerized copper substrate allows for a breathable material in the barrier layer 120 that binds the copper particles and will not release the copper particles as the user inhales and exhales breath through the filtration system 100.

The copper used to form the polymerized copper substrate can be any particulate pure copper (Cu+2) capable of reacting with the harmful substances described herein. For example, the copper particles of the particulate pure copper can range in size from about 7 to about 45 micron (μm) in any dimension. The copper particles can be at least 99% pure copper in one embodiment, or at least 99.7% pure copper in another embodiment. As pure copper, the particulate copper is highly reactive copper. The copper particles will not be as effective or bind to the polymer as well if copper oxide or ionic copper is used as compared to particulate pure copper. Specifically, as copper is oxidized the reactive material decreases. Therefore, the purity of the copper particles used to coat the barrier layer 120 as described herein can be used to increase the reactivity of the resulting barrier layer 120.

In at least one instance, the copper particles of the barrier layer 120 can have an increased surface area to allow for a larger area that can interact with the harmful particles. For example, the copper particles of the barrier layer 120 can include a surface area of between about 5 and about 45 microns (μm) or any subrange therein. The surface of the copper particles can be roughened to increase the surface area available for reaction as compared to a smooth surface. In at least one instance, the surface of the copper particles are scratched, etched, or otherwise altered in order to increase the surface area of each individual particle. In another instance, the copper particles can be of irregular shape or have a complex surface area. The increased surface area of the copper particles provides a greater likelihood that the harmful particles can react with the copper particles.

As illustrated in FIG. 1A, two textile layers 110 can be included on either side of the barrier layer 120, binding the barrier layer 120 therein. The textile layers 110 can be made of a filter media having a mesh sized to filter out harmful substances, such as those described above. The textile layers 110 are designed to create a tortuous path for particles entering the filtration system 100, thus filtering out a large amount of harmful particles prior to reaching the active barrier layer 120. As shown in FIG. 1B, the textile layers 110 can be made of a mesh material. Specifically, the textile layers may comprise any size mesh material, as long as the mesh is small enough to provide a tortuous path for harmful particles and large enough to provide breathability.

In at least one example, the textile layers 110 be made of a filter media such as high-quality textiles and fabrics that ensure no loose fibers will be inhaled by a wearer. In at least one instance, the textile layers 110 and the filtration media of the barrier layer 120 can be the same. The textile layers 110 are secured to either side of the barrier layer 120 to provide filtration of harmful particles as they enter the filtration system 100. Additionally, the textile layers 110 provide protection from loose particles, thus containing a portion of polymerized copper that might become loose or dislodged. The textile layer 110 closest to the wearer's face will prevent the wearer from breathing in any copper particles.

In at least one instance, each of the textile layers 110 of the filtration system 100 can be identical, such that a wearer can place the filtration system in their facial covering in either direction. Additionally, the symmetrical nature of the filtration system 100 allows for filtration and removal of harmful substances both as the wearer breathes in and exhales through their facial covering, providing protection for both the wearer and those around them.

Various standards are used in indicating the effectiveness of filters for facial coverings. One standardized system is the filtering face piece (FFP) standards. The FFP standards are mechanical filter standards commonly used for protective respirator masks certified by the European Union. FFP-standard filters are capable of protecting a wearer against particles such as dust, droplets, and aerosols. There are three FFP classes: FFP1 filters are sufficient for filtering at least 80% of airborne particles; FFP2 are sufficient to filter at least 94% of airborne particles; and FFP3 are sufficient to filter at least 99% of airborne particles. In at least one instance, the textiles layers 110 are designed to pass the any of the FFP1, FFP2, and/or FFP3 requirements.

As indicated above, copper is known to have antimicrobial properties, allowing copper to reduce the spread of harmful substances including microorganisms such as bacteria, viruses, and fungi. As such, any harmful particles that are able to pass through the tortuous path created by the textile layer 110 will be destroyed when they come into contact with the polymerized copper of the barrier layer 120. The non-contiguous distribution of the copper particles throughout the polymerized substrate allows for extended exposure to harmful substances, rather than brief surface exposure to a copper thread or strand. Additionally, the polymerized copper substrate described herein does not release copper ions as a wearer inhales and exhales.

In at least one instance, activated carbon can be included in the textile layers 110 to provide additional filtration and tortuous properties to the layer. Activated carbon is typically used to remove impurities from a fluid via adsorption and can thus be used in facial coverings to assist in the filtration of droplets. As discussed above, the tortuous path created by the textile layers 110 can significantly reduce the amount of harmful particles that penetrate the filtration system 100 and reach the barrier layer 120. Additional filtering properties can thus extend the useful life of the filtration system 100 by reducing the amount of exposure the barrier layer 120 has with harmful particles.

In at least one instance, the filtration system 100 described herein can effectively be used for up to about four weeks before requiring replacement. In one embodiment, the filtration system can be cleaned using a UV bath, thereby extending the life span.

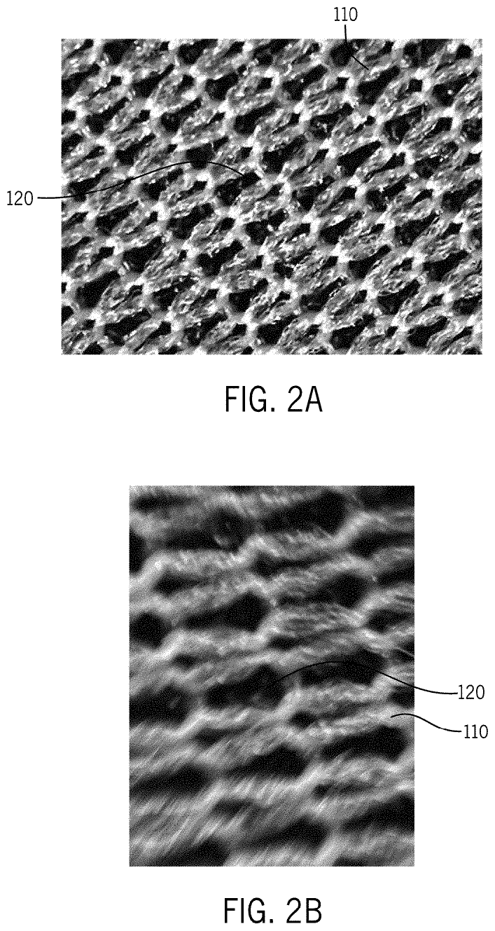

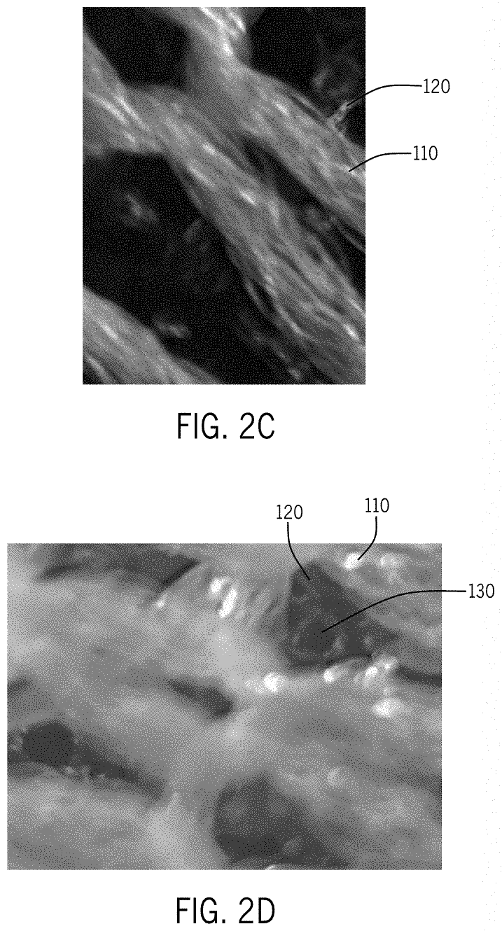

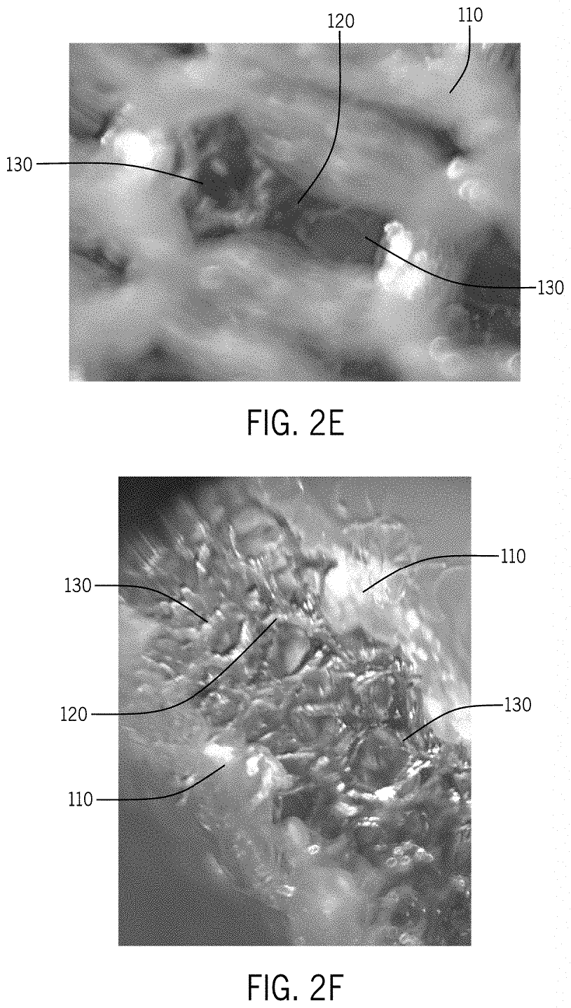

FIGS. 2A-2I are microscopic images of the filtration system 100 as described with respect to FIGS. 1A and 1B. Specifically, the fibers at the surface of the microscopic image are a part of the textile layer 110 illustrated with respect to FIG. 1A. As shown, the textile layer 110 is made of a breathable material that can disrupt the flow of harmful particles through the filtration system. The harmful particles that pass through the textile layer can then come into contact with the barrier layer 120 having a polymerized copper substrate formed therein. The barrier layer 120 is indicated by the material visible through the textile layer 110.

FIGS. 2A-2I provide microscopic images of the same filtration system. FIGS. 2A and 2B are microscopic views of the filtration system at 10× and 20× respective magnifications with the barrier layer 120 visible through a first textile layer 110 of a filtration system 100. FIGS. 2C-2E are microscopic views of the filtration system at 100× magnification with the barrier layer 120 visible through a first textile layer 110. In FIGS. 2C-2E, open cells 130 of the open cell structure of the barrier layer 120 are visible through the holes of the first textile layer 110. For example, see open cells 130 in FIGS. 2D and 2E. FIG. 2F is a cross-sectional microscopic view of the filtration system at 100× magnification showing the barrier layer 120 disposed between first and second textile layers 110 of a filtration system 100. In the illustrated embodiment, the thickness of the barrier layer 120 is in the range of 5 to 10 times thicker than each of the textile layers 110. Open cells 130 of the open cell structure of the barrier layer 120.

A method of making the filtration system can include, as described above, bonding a particulate copper with a polymer substrate producing a polymerized copper substrate having the copper particles reacted therein. Due to the use of particulate copper, the copper can be spread throughout the polymerized copper substrate as individual, non-contiguous particles rather than a contiguous copper material. As described in detail above, the particulate copper particles can have an irregular or rough surface to provide additional reactive area. The liquid copper substrate can be used to coat a breathable filter media to saturate the filter media with the particulate copper to form the barrier layer.

The barrier layer can then be bound between two textile layers. As described above, each of the textile layers is formed of a breathable filter material that provides a tortuous path for harmful particles therethrough. In at least one instance, the textile layers are formed of the same filter media as the barrier layer. In the alternative, the textile layers can be formed of a different filter media that the barrier layer.

The filtration system can then be placed within the pocket of a reusable mask to provide protection against harmful materials. The presently disclosed filtration substance has been shown to kill the harshest bacteria and viruses in reputable studies over the years and very recently, also against the corona virus strains. Recently, a class 3 laboratory was used to test the filtration system to confirm testing against the virus strain that causes COVID-19. The following experimental data is provided to illustrate the effectiveness of the filtration system of the present disclosure. The experimental data is provided as illustrative and is not intended to limit the scope of the present disclosure and should not be so interpreted.

### EXPERIMENTAL ANALYSES

Experiment 1

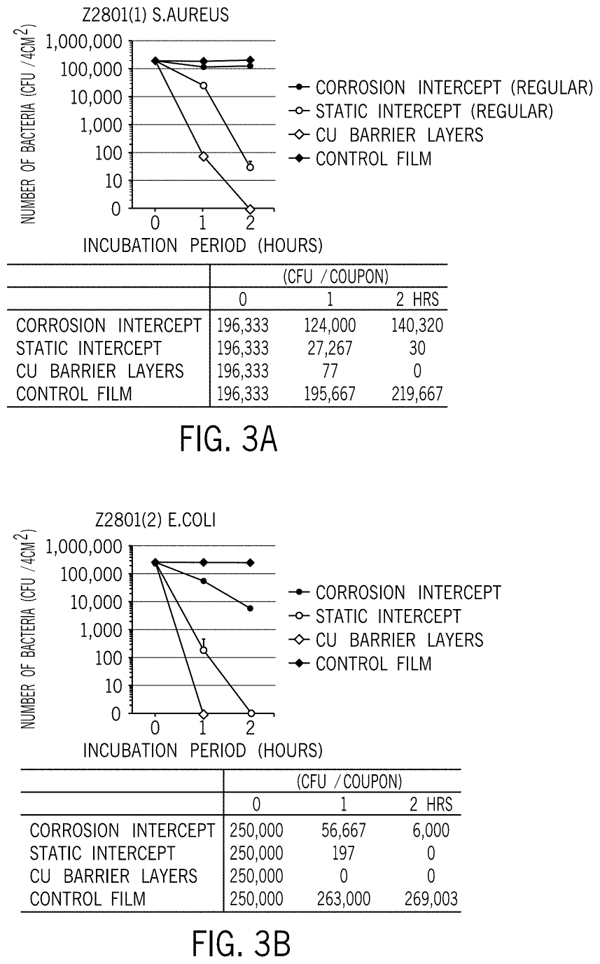

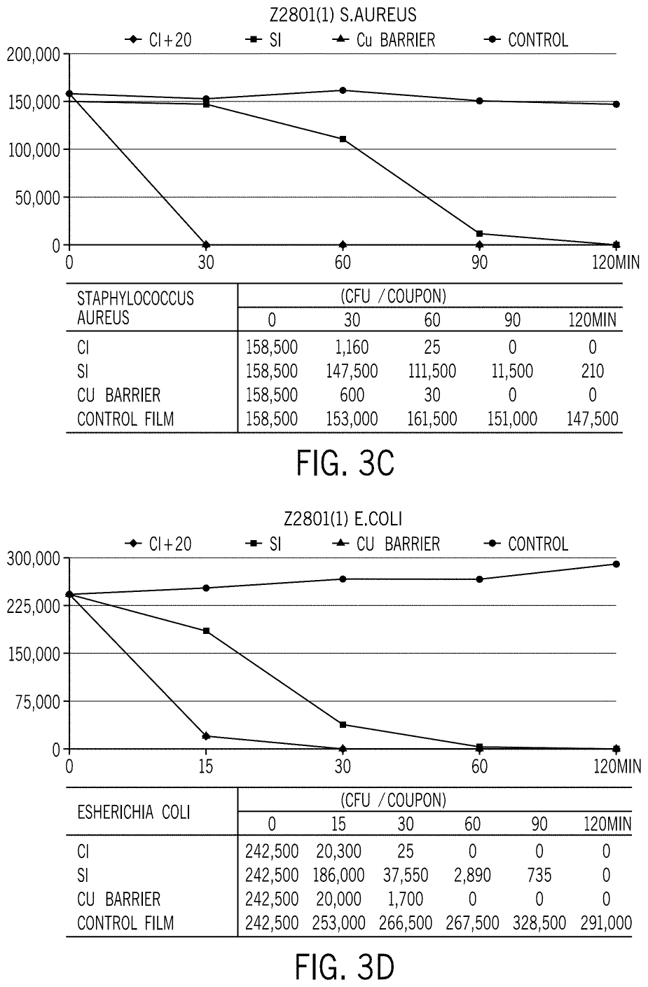

Various materials were exposed to different bacterial strains to determine the number of bacteria that remained present on the material after a specified period of time. Specifically, the present experiment evaluated the antimicrobial attributes of a corrosion intercept (having a copper loading of 11 weight percent), a static intercept (having a copper loading of 15 weight percent plus carbon black), a copper barrier surface in accordance with embodiments of the present disclosure (having a copper loading of 18 weight percent), and a control film on Staphylococcus aureus (S. aureus) and Escherichia coli (E. coli) bacteria for an incubation period of two hours. As indicated in the graphs provided as FIGS. 3A and 3B, the number of bacteria present on the copper barrier surface (having a copper loading of 18 weight percent) was reduced dramatically over the two-hour incubation period for both S. aureus and E. coli, respectively. The static intercept (having a copper loading of 15 weight percent plus carbon black) performed better than the corrosion intercept (having a copper loading of 11 weight percent) and the control, but required more time than the copper barrier surface (having a copper loading of 18 weight percent) to reduce the bacteria to 0.

A secondary test for antimicrobial activity against the same bacteria was performed using corrosion intercept, a static intercept, a copper barrier in accordance with embodiments of the present disclosure, and a control film. As shown in the graphs illustrated in FIGS. 3C and 3D, the number of bacteria present on the copper barrier and the corrosion intercept were reduced to nearly 0 within 30 minutes. The static intercept was reduced to nearly 0 within 60-90 minutes depending on the strain of S. aureus and E. coli, respectively.

Experiment 2

The antimicrobial activity and efficacy of a coated film was evaluated. Three samples of coated film, each having the dimensions 150 mm×150 mm were provided including (1) AGG 18_0, (2) AGG 18_2, and (3) AGG 25_0. The first number in each coating name indicates a copper concentration (e.g., 18 or 25), the second number provided indicates an amount of silver added to the system. The test microorganisms included Staphylococcus aureus (ATCC 6538P); Escherichia coli (ATCC 8739); and Escherichia coli (NCTC12900). Each of the coated films was subjected to the test microorganism for a period of 24 hours, an average number of viable cells of the test microorganism was determined at the beginning and the end of the 24-hour period. The results of each test are provided in Tables 1-3, below.

TABLE 1
Test microorganism

| (Bacterial cells | Average of the number | | |
|---|---|---|---|
| per test piece) | of viable cells | | Values of Anti- |
| Staphylococcus aureus | of test microorganism | | microbial Activity |
| (ATCC 6538P) | per test piece | | (Criteria: Not |
| (1.5 × 10³ cells) | 0 hour | 24 hour | less than 2.0) |
| Uncoated film (Control) | 87 000 | 1 800 000 | — |
| Coated film (AGG 18_0) | — | Less than 10 | More than 5.3 |
| Coated film (AGG 18_2) | — | Less than 10 | More than 5.3 |
| Coated film (AGG 25_0) | — | Less than 10 | More than 5.3 |

TABLE 2
Test microorganism

| (Bacterial cells | Average of the number | | |
|---|---|---|---|
| per test piece) | of viable cells | | Values of Anti- |
| Escherichia coli | of test microorganism | | microbial Activity |
| (ATCC 8739) | per test piece | | (Criteria: Not |
| (1.8 × 10³ cells | 0 hour | 24 hour | less than 2.0) |
| Uncoated film (Control) | 64 000 | 110 000 | — |
| Coated film (AGG 18_0) | — | Less than 10 | More than 4.0 |
| Coated film (AGG 18_2) | — | Less than 10 | More than 4.0 |
| Coated film (AGG 25_0) | — | Less than 10 | More than 4.0 |

TABLE 3
Test microorganism

| (Bacterial cells | Average of the number | | |
|---|---|---|---|
| per test piece) | of viable cells | | Values of Anti- |
| Escherichia coli | of test microorganism | | microbial Activity |
| (NCTC12900) | per test piece | | (Criteria: Not |
| (0.7 × 10³ cells) | 0 hour | 24 hour | less than 2.0) |
| Uncoated film (Control) | 54 000 | 20 000 000 | — |
| Coated film (AGG 18_0) | — | Less than 10 | More than 6.3 |
| Coated film (AGG 18_2) | — | Less than 10 | More than 6.3 |
| Coated film (AGG 25_0) | — | Less than 10 | More than 6.3 |

For each of the above calculations, the Antimicrobial Activity was calculated as log₁₀ of average the number of viable bacterial cells on the uncoated films (Control) after 24 hours minus the log₁₀ of average of the number of viable bacterial cells on the antimicrobial coated films after 24 hours. As indicated in Tables 1-3, the three coated films showed a desirable amount of antimicrobial activity in the presence of each of the test microorganisms. As such, a copper concentration of 18 to 25 percent is sufficient to produce the desired antimicrobial effects.

Experiment 3

A novel copper technology was brought into contact with a known population of microorganisms for a specified period of time at a specific temperature. Sampling was performed at the intervals of 0, 1, and 3 hours post inoculum drying on the test surface, and the surviving microorganisms were enumerated.

The isolates to be evaluated were retrieved from a −80° C. freezer and plated on a Blood Agar Plate (BAP). The plates were incubated at 36° C. in ambient air for 24 hours. Post incubation, 3 medium-sized colonies were inoculated into 5 mL of Tryptic Soy Broth (TSB). The tubes were then incubated for 24 hours at 36° C.

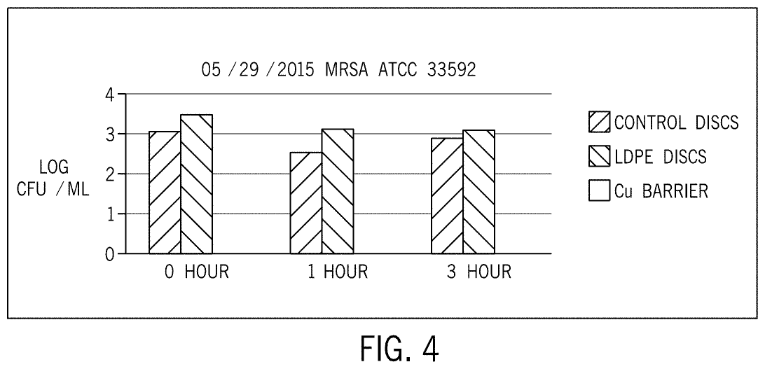

Testing discs having a 2-inch diameter of copper discs, LDPE control, and autoclavable control disc were used for testing. The discs were cleaned with alcohol, rinsed with sterile deionized water, and allowed to air dry. The testing discs of autoclavable plastic, discs covered with LDPE, and discs covered with copper film were inoculated with a bacterial suspension of Methicillin-Resistant Staphylococcus aureus (MRSA). The testing discs were sampled at each of the stated intervals and an amount of bacterium was determined. The results of the experiment are provided in the graph illustrated in FIG. 4. As shown, the copper discs (akin to copper barrier layer of the present disclosure) showed no significant microbial activity at any of the intervals tested, indicating good antimicrobial activity in the presence of MRSA.

Experiment 4

Antiviral activity of the present filtering system was evaluated in the presence of Bovine Coronavirus (BCoV). The present experiment was performed using a barrier layer as described herein. The barrier layer includes an open cell foam coated with polymerized copper.

The test was performed at room temperature using a 200 μL of viral inoculum with known viral type applied to each of several specimen including the barrier layer foam and an inert foam layer. The inoculum was left adsorbing onto the specimen at room temperature and under a biosafety hood.

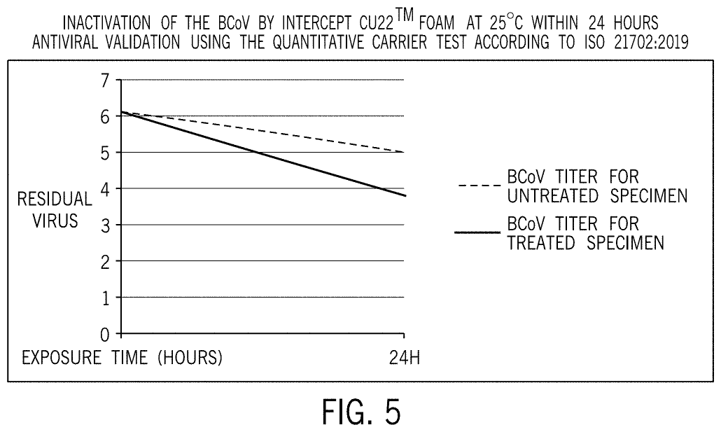

The test was performed using Bovine Coronavirus (BCoV)—strain S379 Riems for contact periods of 30 minutes, 1 hour, and 24 hours (±5 minutes). The results of the analysis is provided in the graph of FIG. 5. As indicated in the graph, the BCoV on the treated specimen showed a significantly lower activation after 24 hours.

Experiment 5

Antiviral activity of the present filtering system was evaluated in the presence of Bovine Coronavirus (BCoV), as described above. The present experiment however used barrier layer which included extruded PE film with polymerized copper.

The test was performed at room temperature using a 400 μL of viral inoculum with known viral type applied to each of several specimen including the barrier layer and an inert foam layer. The inoculum was left adsorbing onto the specimen at room temperature and under a biosafety hood.

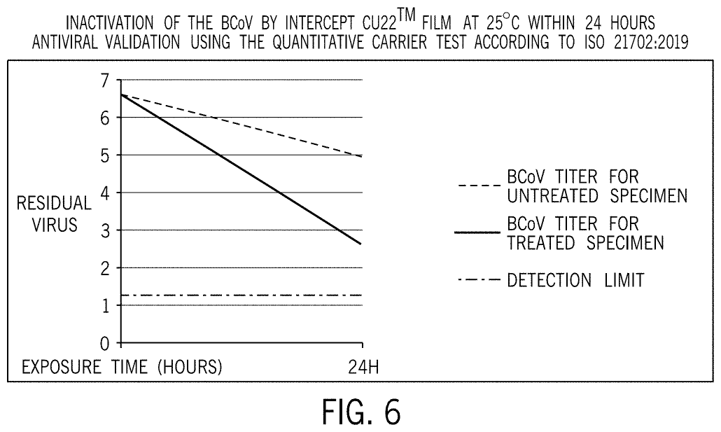

The test was performed using Bovine Coronavirus (BCoV)—strain S379 Riems for contact periods of 30 minutes, 1 hour, and 24 hours (±5 minutes). The results of the analysis are provided in the graph of FIG. 6. As indicated in the graph, the BCoV on the treated specimen showed a significantly lower activation after 24 hours

Even though the experiments discussed herein indicate that the present filtration system is effective against viruses and bacterial, such harmful substances can remain survive outside the filtration system on a reusable face covering. It should be generally understood that re-usable facial coverings should be washed frequently and temperatures of at least 140° F. to prevent microbial activity.

Although several embodiments have been described in language specific to structural features and/or methodological acts, it is to be understood that the claims are not necessarily limited to the specific features or acts described. Rather, the specific features and acts are disclosed as illustrative forms of implementing the claimed subject matter.

What is claimed is:

1. An active barrier layer for use in a filtration system, the barrier layer comprising:
a breathable filter media; and
a coating on the filter media wherein the coating includes particulate copper and a polymer, wherein the particulate copper is present in an amount of from about 5 to about 38 percent by weight based on the total weight of the coating, wherein the particulate copper is bound to the polymer to form a polymerized copper substrate.

2. The active barrier layer of claim 1, wherein the copper particles are dispersed in a non-contiguous distribution throughout the filter media.

3. The active barrier layer of claim 1, wherein the filter media is an open cell foam.

4. The active barrier layer of claim 1, wherein the particulate copper is at least 99% pure copper (Cu+2).

5. The active barrier layer of claim 1, wherein the particulate copper is present in an amount of from about 12 to about 25 percent by weight based on the total weight of the liquid copper substrate.

6. The active barrier layer of claim 1, wherein the particulate copper is present in an amount of from about 18 to about 25 percent by weight based on the total weight of the liquid copper substrate.

7. The active barrier layer of claim 1, wherein the particulate copper has a surface area in the range of between about 5 and about 45 microns.

8. The active barrier layer of claim 1, wherein the particulate copper has an increased surface area created by scratching and/or etching.

9. The active barrier layer of claim 1, wherein the particulate copper is included in an amount effective in killing viruses and bacteria.

10. The active barrier layer of claim 1, wherein the particulate copper is included in an amount effective in killing coronavirus strains.

11. The active barrier layer of claim 1, wherein the particulate copper is included in an amount effective in killing bacteria including Staphylococcus aureus and Escherichia coli (E. coli).

12. A filtration system for facial coverings, the filtration system comprising:
a barrier layer having a coating on the filter media, wherein the coating includes particulate copper and a polymer, wherein the particulate copper is present in an amount of from about 5 to about 38 percent by weight based on the total weight of the coating, wherein the particulate copper is bound to the polymer to form a polymerized copper substrate; and
at least two textile layers disposed on either side of the barrier layer, wherein the at least two textile layers have filtering properties.

13. The filtration system of claim 12, wherein the at least two textile layers have a mesh size sufficient to prevent 99% of all droplets and particles from passing therethrough.

14. The filtration system of claim 12, wherein the at least two textile layers have a mesh size sufficient to prevent particulate copper from passing therethrough.

15. The filtration system of claim 12, wherein the filter media of the barrier layer is an open cell foam.

16. The filtration system of claim 12, wherein the particulate copper is at least 99% pure copper (Cu+2).

17. The filtration system of claim 12, wherein the particulate copper is present in an amount of from about 12 to about 25 percent by weight based on the total weight of the liquid copper substrate or in an amount of from about 18 to about 25 percent by weight based on the total weight of the liquid copper substrate.

18. The filtration system of claim 12, wherein the particulate copper has a surface area in the range of between about 5 and about 45 microns.

19. A method for making an active barrier layer, comprising:
producing a liquid polymerized copper substate having particulate copper present in an amount of from about 5 to about 38 percent by weight based on the total weight of the coating; and
creating a barrier layer by coating a breathable filter media with the liquid copper substrate to coat the filter media with polymerized copper.

20. A method for making a filtration system for use with a facial covering, the method comprising:
producing a liquid polymerized copper substate;
creating a barrier layer by coating a filter media with the liquid copper substrate to coat the filter media with polymerized copper; and
binding the barrier layer between two textile layers, wherein each of the two textile layers provides a tortuous path for particles to pass therethrough.
